(19) United States
(12) Patent Application Publication
(10) Pub. No.: US 2013/0201070 A1
(43) Pub. Date: Aug. 8, 2013

(54) WIRELESS COMMUNICATIONS DEVICE HAVING LOOP WAVEGUIDE TRANSDUCER WITH SPACED APART COUPLING POINTS AND ASSOCIATED METHODS

(71) Applicant: Francis Eugene Parsche, Palm Bay, FL (US)

(72) Inventor: Francis Eugene Parsche, Palm Bay, FL (US)

(73) Assignee: Harris Corporation, Melbourne, FL (US)

(21) Appl. No.: 13/365,010

(22) Filed: Feb. 2, 2012

(51) Int. Cl. H01Q 13/02; H04R 31/00; H01Q 13/00

(52) U.S. Cl. 343/786; 343/772; 29/594

(57) ABSTRACT

A wireless communications device may include wireless communications circuitry and a waveguide transducer coupled to the wireless communications circuitry. The waveguide transducer may include a loop electrical conductor having a plurality of spaced apart gaps therein defining a plurality of respective spaced apart coupling points. The waveguide transducer may also include a feed assembly that may include at least one waveguide feed, and a feed network coupled between the at least one waveguide feed and the plurality of coupling points. The waveguide transducer may further include a waveguide surrounding the loop electrical conductor and extending outwardly therefrom. The waveguide may include a tubular body having an open end and an opposing closed end carrying the loop electrical conductor.

### FIELD OF THE INVENTION

The present invention relates to the field of communications, and more particularly, to loop type antennas, circular polarization, dual polarization and related methods.

### BACKGROUND OF THE INVENTION

The use of satellite communications has increased the demand for circularly polarized antennas and for dual polarization antennas. For instance, many of the satellite transponders in use today carry two programs on the same frequency by using separate polarizations. Thus, single antenna structure may be called upon to simultaneously receive two polarizations, or perhaps to transmit in one polarization and receive in another. The single antenna structure should therefore separate the two polarization channels, to a high degree of isolation.

It is possible to have dual linear or dual circular polarization channel diversity. That is, a frequency may be reused if one channel is vertically polarized and the other horizontally polarized. Or, a frequency can also be reused if one channel uses right hand circular polarization (RHCP) and the other left hand circular polarization (LHCP). Polarization refers to the orientation of the E field in the radiated wave, and if the E field vector rotates in time, the wave is then said to be rotationally or circularly polarized.

An electromagnetic wave has an electric field that varies as a sine wave within a plane coincident with the line of propagation, and the same is true for the magnetic field. The electric and magnetic planes are perpendicular and their intersection is in the line of propagation of the wave. If the electric-field plane does not rotate (about the line of propagation) then the polarization is linear. If, as a function of time, the electric field plane (and therefore the magnetic field plane) rotates, then the polarization is rotational. Rotational polarization is in general elliptical, and if the rotation rate is constant at one complete cycle every wavelength, then the polarization is circular.

The polarization of a transmitted radio wave is determined in general by the antennas shape and the type of current flowing on that shape. In general, antenna types may be classified as to dipoles and loops, based on the divergence or curl of current. The canonical forms of the dipole and loop antennas are the line and circle. Of course there can be hybrid antennas that use both divergence and curl. Preferred antenna shapes are often Euclidian, being simple geometric shapes known for optimization through the ages.

For example, the monopole antenna and the dipole antenna are two common examples of divergence antennas with linear polarization. A helix antenna is a common example of a hybrid divergence and curl antenna with circular polarization. Another example of a circularly polarized antenna is a crossed array of dipoles fed in phase quadrature, e.g. the “Turnstile”. Linear polarization is usually further characterized as either Vertical or Horizontal. Circular Polarization is usually further classified as either Right Hand or Left Hand.

The dipole antenna has been perhaps the most widely used of all the antenna types. It is of course possible however to radiate from a conductor which is not constructed in a straight line. Approaches to circular polarization in loop antennas appear lesser known, or perhaps even unknown in the purest forms. In spite of the higher gain of the full wave loop vs. the half wave dipole (3.6 dBi vs. 2.1 dBi), dipoles are commonly used for circular polarization needs, as for instance in turnstile arrays. A circle antenna structure can be more suited for circular polarization than an X antenna. Both the dipole turnstile and a single loop antenna are planar, in that their thin structure lies nearly in a single plane.

Many structures are described as loop antennas, but the circle shape best provides the curling motion, and a circle advantageously provides the most area for the least circumference. The resonant loop is a full wave circumference circular conductor, often called a “full wave loop”. The typical prior art full wave loop is linearly polarized, having a radiation pattern that is a two petal rose, with two opposed lobes normal to the loop plane, and a gain of about 3.6 dBi. Reflectors are often used with the full wave loop antenna to obtain a unidirectional pattern.

Dual linear polarization (simultaneous vertical and horizontal polarization from the same antenna) has commonly been obtained from crossed dipole antennas. For instance, U.S. Pat. No. 1,392,221 to Runge, proposes a crossed dipole system. Polarization diversity was recited. The embodiment shown in FIG. 3 and described on page 2 lines 20-29 also provided circular polarized reception.

U.S. Pat. No. 5,977,921 to Niccolai et al. is directed to an antenna for transmitting and receiving circularly polarized electromagnetic radiation which is configurable to either right-hand or left-hand circular polarization. The antenna has a conductive ground plane and a circular closed conductive loop spaced from the plane, i.e., no discontinuities exist in the circular loop structure. A signal transmission line is electrically coupled to the loop at a first point and a probe is electrically coupled to the loop at a spaced-apart second point. This antenna requires a ground plane and includes a parallel feed structure, such that the RF potentials are applied between the loop and the ground plane. The “loop” and the ground plane are actually dipole half elements to each other, and the invention is related to microstrip antennas.

U.S. Pat. No. 5,838,283 to Nakano is directed to a loop antenna for a circularly polarized wave. Driving power fed may be conveyed to a feeding point via an internal coaxial line and a feeder conductor is transmitted through an I-shape conductor to a C-type loop element disposed in spaced facing relation to a ground plane. By the action of a cutoff part formed on the C-type loop element, the C-type loop element radiates a circularly polarized wave. Dual linear, or dual circular polarization are not however provided.

U.S. Pat. No. 6,522,302 to Iwasaki is directed to a circularly polarized antenna array rather than a single circularly polarized loop element. A circle is among the most elemental of antenna structures, and it is a fundamental single geometry capable of circular polarization.

U.S. Pat. Pub. No. 2008/0136720 to Parsche, the inventor of the present application, discloses a multiple polarization loop antenna which includes a circularly polarized loop antenna. The circularly polarized loop antenna utilizes a loop electrical conductor and two signal feedpoints along the loop electrical conductor separated by one quarter of the length of the loop circumference for a signal feedpoint phase angle input difference of 90 degrees. Each of the signal feedpoints includes a loop discontinuity, so that at least one signal source coupled thereto provides circular polarization from the loop electrical conductor. The circularly polarized loop antenna provides an increase in gain and decrease in size relative to the dipole turnstile. It can provide two orthogonal polarizations from two isolated ports, and the polarizations may be dual linear or dual circular.

While U.S. Pat. Pub. No. 2008/0136720 represents an exemplary advance in the field of circularly polarized loop antennas, further advances are still desirable. For example, improvement to the degree of circularity of the polarization can help improve antenna performance, and a single antenna structure capable of both circular and linear polarization would be useful in some applications.

### SUMMARY OF THE INVENTION

In view of the foregoing background, it is therefore an object of the present invention to provide a wireless device having a waveguide transducer that can be configured for different polarizations.

This and other objects, features, and advantages in accordance with the present invention are provided by a wireless communications device that includes wireless communications circuitry, and a waveguide transducer coupled to the wireless communications circuitry. The waveguide transducer includes a loop electrical conductor having a plurality of spaced apart gaps therein defining a plurality of respective spaced apart coupling points. The waveguide transducer also includes a feed assembly that includes at least one waveguide feed, and a feed network coupled between the at least one waveguide feed and the plurality of coupling points. The waveguide transducer includes a waveguide surrounding the loop electrical conductor and extending outwardly therefrom. The waveguide includes a tubular body having an open end and an opposing closed end carrying the loop electrical conductor. Accordingly, the waveguide transducer allows operation using both linear and circular polarization, for example, and provides robust performance.

A method aspect is directed to a method of making a waveguide transducer for use in a wireless communications device. The method includes forming a loop electrical conductor having a plurality of spaced apart gaps therein defining a plurality of respective spaced apart coupling points. The method also includes forming a feed assembly by forming a feed network and coupling the feed network between at least one waveguide feed and the plurality of coupling points, and positioning a waveguide to surround the loop electrical conductor and extend outwardly therefrom.

### BRIEF DESCRIPTION OF THE DRAWINGS

FIG. 1 is a schematic diagram of an embodiment of a wireless communications device in accordance with the present invention wherein the antenna is configured for circular polarization operation.

FIG. 2 is a schematic diagram of an embodiment of a wireless communications device in accordance with the present invention wherein the antenna is configured for simultaneous left hand and right hand circular polarization operation.

FIG. 3 is a schematic diagram of an embodiment of a wireless communications device in accordance with the present invention wherein the antenna is configured for linear polarization operation.

FIG. 4 is a schematic diagram of an embodiment of a wireless communications device in accordance with the present invention wherein the antenna is configured for both horizontal and vertical linear polarization operation.

FIG. 5A is a diagram depicting the antenna of FIG. 1 in a standard radiation pattern coordinate system.

FIGS. 5B-5D are graphs depicting the principal plane radiation pattern cuts of the antenna of FIG. 1 in free space.

FIG. 6 is a plot of the voltage standing wave ratio (VSWR) response at a loop port on the antenna of FIG. 1.

FIG. 7 is a plot of the impedance response at a loop port on the antenna of FIG. 1, in Smith Chart format.

FIG. 8 is a schematic diagram of an embodiment of a wireless communications device in accordance with the present invention including a waveguide transducer.

FIG. 9 is an enlarged top view of the waveguide transducer of FIG. 8.

FIG. 10 is a schematic diagram of another embodiment of a wireless communications device in accordance with the present invention including a waveguide transducer.

FIG. 11 is a Smith Chart of driving point impedance for the waveguide transducer of FIG. 10.

FIG. 12 is a simulated voltage standing wave ratio graph for the waveguide transducer of FIG. 10.

FIG. 13a illustrates the waveguide transducer of FIG. 10 without the horn in a radiation pattern coordinate system.

FIGS. 13b-13d are radiation patterns for the waveguide transducer of FIG. 10 without the horn.

FIGS. 14a-14c are field rotation graphs for the waveguide transducer of FIG. 10 with an applied alternating current.

FIG. 15 is a graph of the axial ratio for the waveguide transducer of FIG. 10.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

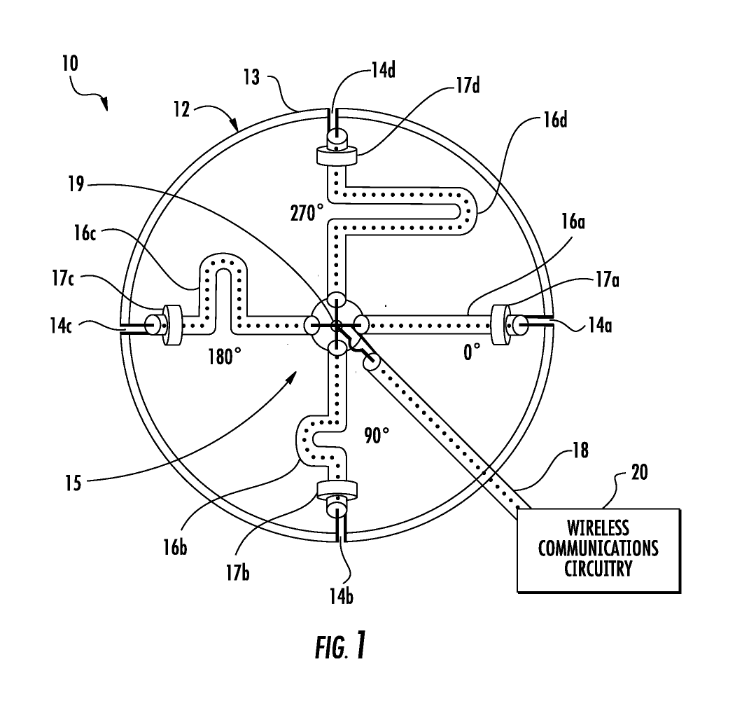

Referring initially to FIG. 1, a wireless communications device 10 includes wireless communications circuitry 20 and an antenna 12 coupled to the wireless communications circuitry 20. The wireless communications device 10 may be a satellite transceiver in some embodiments, and as such, the wireless communications circuitry 20 may include transmitter and/or receiver circuitry.

The antenna 12 comprises a loop electrical conductor 13, which is preferably circularly shaped. The loop electrical conductor 13 may be a metallic ring, circular wire, tubing hoop, a conductive trace, or may be a hole defined in a metallic surface, as will be appreciated by those of skill in the art. Approximations the circle shape may also be used, such as polygons. The loop electrical conductor 13 has four spaced apart gaps therein which define four respective spaced apart coupling points 14a, 14b, 14c, 14d. Each of the spaced apart gaps may create a pair of terminals on either side of the gap. The spaced apart coupling points 14a, 14b, 14c, 14d may comprise ports.

The spaced apart coupling points 14a, 14b, 14c, 14d are separated by one quarter of a length of the circumference of the loop electrical conductor 13, and the length of the loop electrical conductor itself corresponds to an operating wavelength of the antenna 12. In particular, good results may be obtained with the circumference of the loop electrical conductor 13 being equal to the operating wavelength of the antenna 12, although it should be noted that the loop electrical conductor 13 circumference may also be multiples and/or fractions of the operating wavelength.

The antenna 12 includes a feed assembly 15, to relay signals to and from the wireless communications circuitry 20, as well as to configure the antenna for different modes of operation, as will be explained in detail below. The feed assembly 15, in turn, includes an antenna feed 18 which is coupled to the wireless communications circuitry 20. The antenna feed 15 in turn is coupled to each of four signal feed lines 16a, 16b, 16c, 16d at a common node 19. The signal feed lines 16a, 16b, 16c, 16d are illustratively delay lines, but it should be understood that they need not be. Each delay line 16a, 16b, 16c, 16c is coupled to a respective one of the coupling points 14a, 14b, 14c, 14d. The feed assembly 15 divides radio frequency power four ways and delivers the divided power at different relative phases. Baluns 17a, 17b, 17c, 17d may be provided suppress common mode currents on feed assembly 15, such as ferrite beads. Baluns 15 may also be balun transformers to the match coupling point 14a, 14b, 14c, 14d impedances to the feed assembly 15, if desired.

As can be appreciated by those in the art, FIG. 1 depicts the delay lines 16a, 16b, 16c, 16c to be connected in parallel at the common node 19. This will provide equal power division into the four delay lines 16a, 16b, 16c, 16c when the impedance referred by the four delay lines 16a, 16b, 16c, 16d are equal. Of course other means of power division may also be used at the common node 19, such as series connections of the delay lines 16a, 16b, 16c, 16c, any combination of series and or parallel connections, a transformer with multiple windings, a branch line coupler, etc. as those in the art can appreciate.

Since the length of each delay line 16a, 16b, 16c, 16d is illustratively different, each delay line will refer a fraction of the transmit signal to the coupling points 14a, 14b, 14c, 14d at different relative phase, or in the receive case refer the fractions of the receive signal to antenna feed 18 in a reciprocal fashion to the transmit case. Here, the phases shifted versions of the transmit signal are referred to the coupling points 14a, 14b, 14c, 14c, or the phase shifted versions of the receive signal are referred to the antenna feed 18, at 0°, 90°, 180°, and 270° relative phase respectively. The feed assembly 15 may provide equal amplitude excitations in phase quadrature (0, 90, 180, 270 degrees) at the coupling points 14a, 14b, 14c, 14d. For example, if the wireless communications circuitry 20 provides 1 watt of RF power, then the feed assembly 15 provides watt of RF power to each of the coupling points 14a, 14b, 14c, 14d at relative phases of 0, 90, 180 and 270 degrees. This arrangement of phase differences results in a signal being transmitted with circular polarization, in particular right hand circular polarization is produced out of the page. This is because the equal amplitude quadrature phase excitations at the spaced apart coupling points 14a, 14b, 14c, 14d imparts a traveling wave current distribution on the loop electrical conductor 13.

The traveling wave current distribution will be further explained. A traveling wave current distribution means that the loop electrical conductor 13 has a sine wave current distribution which is moving around the circumference of the loop circumference at an angular velocity of ω=2πf. So to speak then, two “lumps of current” rotate around the loop electrical conductor 13 circumference. The two current maxima are opposite each other at all times. Since the flow of RF electric currents cause radio waves, and the RF currents are themselves rotating around the loop, then the transmitted wave must spin around its axis, which is circular polarization.

As background, prior art linearly polarized full wave loop antennas have an electrical current distributions on the loop conductor that does not spin around the loop circumference. Rather, the two current maxima stand still in space.

A theory of operation for a circular loop electrical conductor 13 will now be provided. The four equal amplitude quadrature phase excitations would if summed together in an ordinary fashion cancel and become zero, e.g. the vector sum of 1 [symbol] 0°+1 [symbol] 90°+1 [symbol] 180°+1 [symbol] 270°=0 The structure of the circular loop electrical conductor 13 however has dual properties of: 1) a radiating antenna and 2) a hybrid ring power combiner. So, the circular loop electrical conductor 13 can hybrid combine the RF powers at the coupling points 14a, 14b, 14c, 14d without cancellation, and this produces a traveling wave current distribution. The hybrid power combining properties of the circular loop electrical conductor 13 are as follows: port 14a is uncoupled from port 14b, port 14b is uncoupled from port 14c, port 14c is uncoupled from port 14d, and port 14d is uncoupled from port 14a, or stated as scattering parameters S_{14a14b}=0, S_{14b14c}=0, S_{14c14d}=0. The quadrature excitation and hybrid combining in the loop electrical conductor 13 results in the superposition of sines and cosines in an extension of the Pythagorean Identity:

Iₗₒₒₚ=(sin θ)²+(cos θ)²+(−sin θ)²+(−cos θ)²

Where Iₗₒₒₚ is the current on the loop conductor 13. The sine term corresponds to the 0 degree excitation at coupling point 14a, the cosine to the 90 degree excitation at 14b, the −sine term to the 180 degree excitation at 14c, and the −cosine term to the 270 degree excitation at 14d. The traveling wave current distribution transduces a circularly polarized wave as it is moving in a circle.

If the delay lines 16a, 16b, 16c, 16c are sized such that the phase delay increases in the opposite sense as shown, the circular polarization will be left handed circular polarization produced into the page. So, increasing phase delay (such as more cable length) is introduced in a sense opposite that of the desired circular polarization sense. In addition, as will be appreciated by those of skill in the art, the delay lines 16a, 16b, 16c, 16c need not cause the delay due to a mere function of their length, and need not have different lengths, but may include suitable phase shifting elements therein so as to produce the desired phase shift. Examples include coaxial cables having different permittivity dielectrics or ferrites, and ladder networks of inductors and capacitors.

Regarding the choice of circular polarization sense, right handed circular polarization may be preferential in the northern hemisphere, and left handed circular polarization may be preferable in the southern hemisphere, due to electron rotation (gyro resonance) in the ionosphere (see also “Ionospheric Radio Propagation”, K. Davies. National Bureau of Standards, Apr. 1, 1965).

The far field radiation pattern is the Fourier transform of the current distribution on the loop conductor 13, so the radiated field of the antenna 12 in the Z direction (normal to the loop plane) has a constant magnitude over time which is described by

E=(cos² ωt+sin² ωt)^{1/2}=1,

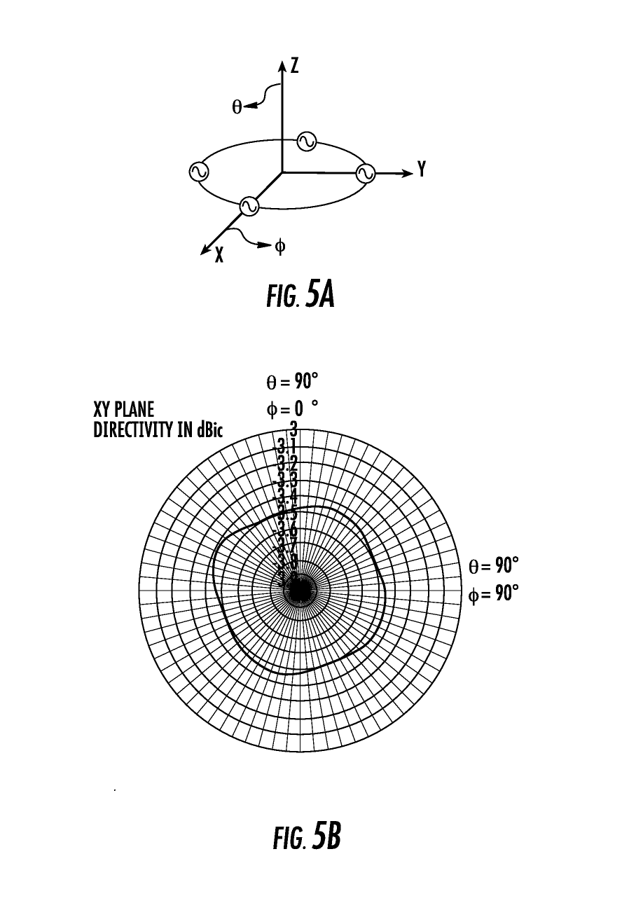

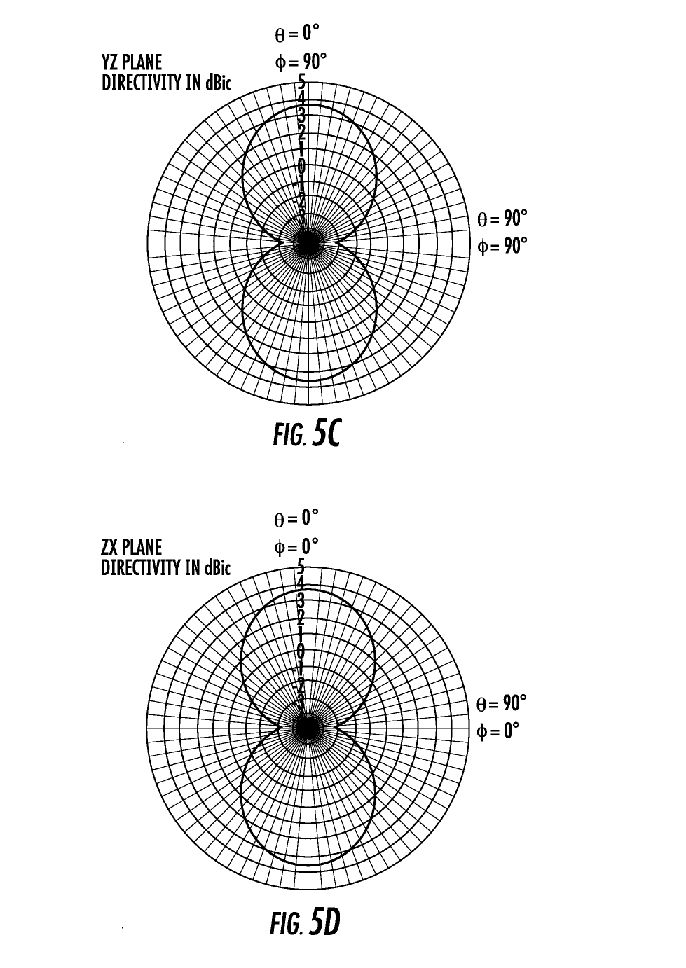

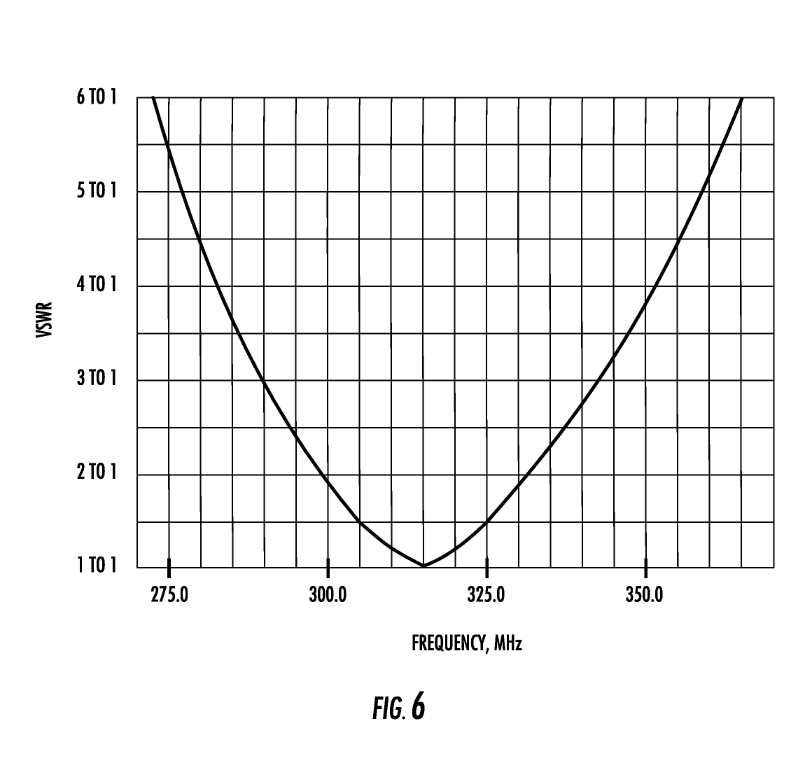

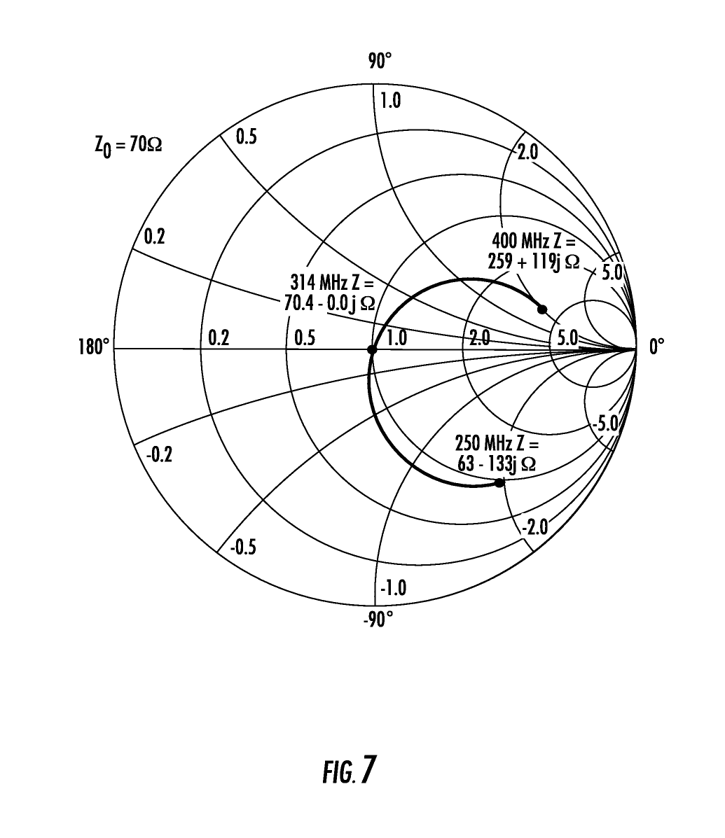

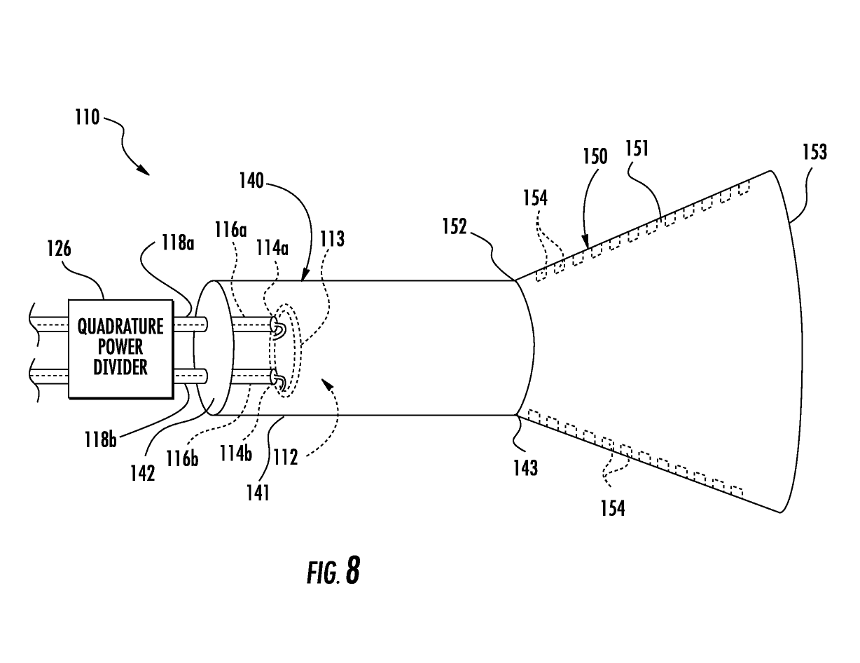

which is the condition for circular polarization. ω is the orientation of the E field about the wave axis, e.g. the polarization angle, and t is time. FIG. 6 depicts the present invention in a standard radiation pattern coordinate system, and examples of the principal plane far field radiation pattern cuts (XY, YZ, ZX) for the present invention circularly polarized loop antenna are depicted in FIGS. 5B-5D. These patterns were obtained by moment method numerical electromagnetic modeling, and are for operation in free space. Total fields are plotted. The plotted quantity is directivity. The units are dBic, expressed in decibels relative to an isotropic radiator that is circularly polarized. If the antenna is efficiently matched and tuned the FIGS. 5B-5D also plot the realized gain in dBic, as can be appreciated by those in the art. The elevation cut patterns are a cosⁿ two petal rose and the two radiation pattern lobes are oriented broadside the loop plane. The half power beamwidth of those lobes is 98 degrees and the beams are symmetric in shape. The FIG. 5B azimuth cut in the loop plane is circular. So the antenna 12 has omnidirectional radiation about the horizon when the antenna plane is horizontal. The FIG. 5B plot uses a fine scale of 1/10 decibel per division to show that the azimuth plane pattern ripple is low, about +−0.25 decibel, and the highly circular azimuth pattern may for instance benefit radio location systems. The antenna 12 has no sidelobes. The gain at pattern peak is 3.6 dBic and this is 1.5 db more than a half wave dipole turnstile (U.S. Pat. No. 1,892,221, to Runge) provides. Polarization in the 5B-5D example was circular broadside to the loop plane and linear in the loop plane. When the loop electrical conductor 13 plane is horizontal the polarization there is horizontal. As background, polarization is the orientation of the E field vector of the far field radio wave.

If a large plane reflector (not shown) is spaced one quarter wavelength (λ/4) from the antenna 12 a single radiation pattern lobe is formed with 82 degrees beamwidth. When efficiently matched and tuned, the realized gain is 8.2 dBic. If a plane reflector is spaced relatively close to the antenna 12 a “patch antenna” may be formed.

The degree of polarization circularity produced by the FIG. 1 embodiment antenna 12 is extremely high and is nearly ideal. Axial ratios of 0.9999 and higher (perfect circular polarization axial ratio equals one) are achievable from the antenna 12 as the four coupling points 14a, 14b, 14c, 14d together enforce the loop current distribution. High axial ratio polarization circularity, from the present invention, may benefit say air traffic radar in looking through rain clutter as rain clutter reflections are known to return circular polarization in the opposite sense, and aircraft tend to be rather random scatterers of polarization.

FIG. 6 depicts the voltage standing wave ratio (VSWR) response of a 1 meter circumference thin wire antenna 12 at each coupling point 14a, 14b, 140, 14d. FIG. 6 is normalized to 70 ohms and as can be appreciated the VSWR is less than 1.1 to 1. So, the antenna 12 is advantageously suited for use with coaxial cables. The VSWR response is quadratic (single tuned), the 2 to 1 VSWR bandwidth at each coupling point 14a, 14b, 14c, 14d is 10.7 percent, and the 6 to 1 VSWR bandwidth is 30.1 percent. The 3 dB gain bandwidth of the antenna 12 may be also be 30.1 percent since a 6 to 1 VSWR may correspond to 3 dB mismatch loss. FIG. 7 plots the driving point impedance at each of the four coupling points 14a, 14b, 14c, 14d in Smith Chart format. For a thin wire loop electrical conductor 13 of wire diameter of λ/1000 the loop circumference is 1.05λ at resonance. The normalizing impedance in FIG. 7 was 70 ohms. As those in the art may appreciate the four delay lines 16a, 16b, 16c, 16d may preferentially have a characteristic impedance of 70 ohms in practice.

The FIG. 1 embodiment may of course provide elliptical polarization if unequal power divisions are provided at the coupling points 14a′, 14b′, 14c′, 14d′.

Fewer than four or more than four coupling points 14 may be used in antenna 12 but the combination of a loop electrical conductor 13 circumference near one wavelength with four equally spaced coupling points 14 is very effective.

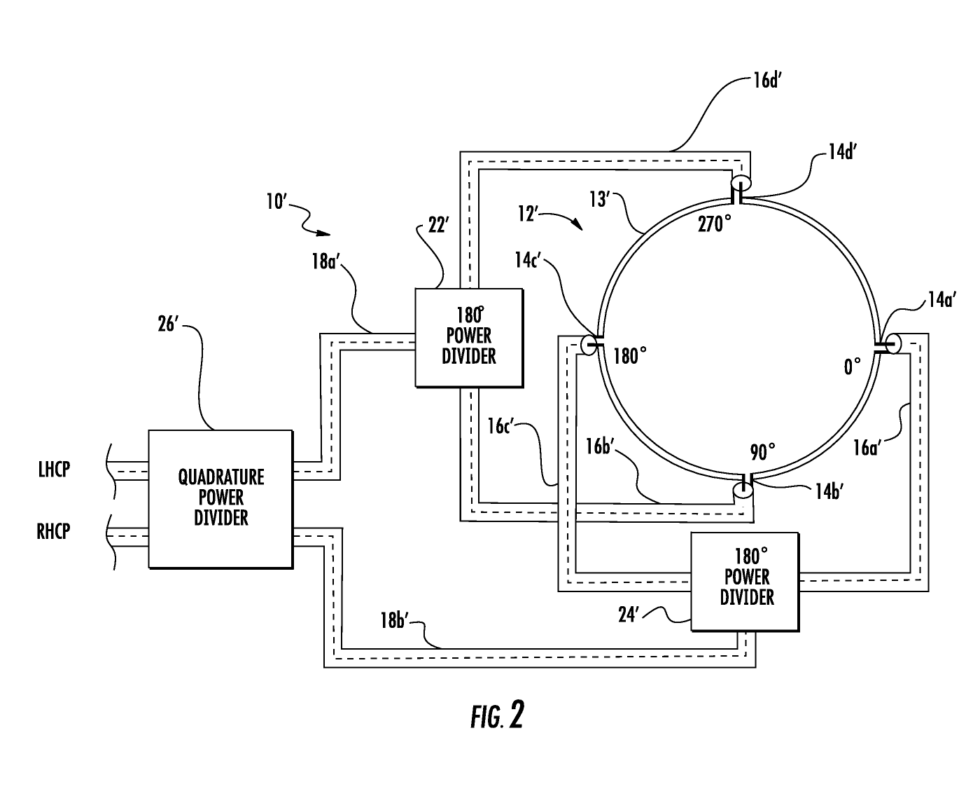

Now described with reference to FIG. 2 is an additional embodiment, wherein the antenna 12′ is configured for operation using simultaneous right hand and left hand circular polarization. The antenna 12 may provide polarization duplexing with high isolation between the opposite polarization senses.

Here, a quadrature hybrid unit 26′ drives the antenna 12′ at the coupling points 14a′, 14b′, 14c′, 14d′, providing 0 and 90 degree phasing at its outputs. In addition, here, there are two antenna feeds 18a′, 18b′, each of which feeds a power divider 22′, 24′, respectively. The power dividers are each coupled to two opposite coupling points (i.e. 14a′ and 14c′, and 14b′ and 14d′) by respective delay lines (i.e. 16a′ and 16c′, 16b′ and 16d′). Here, the delay lines 16a′, 16b′, 16c′, 16d′ are configured to provide phase delays of 0°, 90°, 180°, and 270°, respectively.

As explained, this design provides for transmission or reception of dual circularly polarized signals, allowing for simultaneous transmission of two separate signals. In addition, this design may be used for full duplex communications, where a transmitter may simultaneously be operated at coupling points 14a′ and 14c′, and a receiver at coupling points 14b′ and 14d′, without mutual interference.

This antenna 12′ provides a very high axial ratio which may approach 1.0. Such a high axial ratio means that there is little to no interference of the right hand circularly polarized signal caused by the left hand circularly polarized signal, or vice versa. This is highly desirable in satellite communications, for example for frequency reuse. In addition, this embodiment may be advantageous at high (HF) frequencies for NVIS (near vertical incidence skywave) communications.

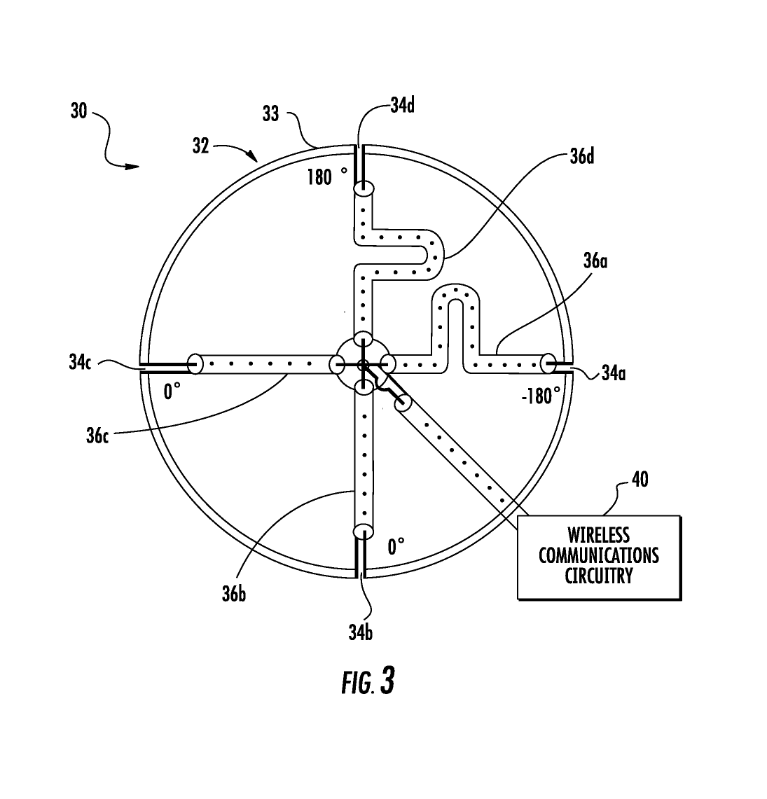

With reference to FIG. 3, a version of the antenna 32 that is configured for linear polarization operation rather than circular polarization is now described. This antenna 32 is similar to the antenna 12 described with reference to FIG. 1, but the delay lines 36a, 36b, 36c, 36d are sized differently. Here, the delay lines 36a, 36b, 36c, 36d are sized such that the phases at the coupling points 34a, 34b, 34c, 34d are −180°, 0°, 0°, and 180°, respectively.

This phase configuration results in linear polarization, rather than circular polarization. In particular, this antenna 32 produces horizontal linear polarization into and out of the page. If the phases at the coupling points were 34a, 34b, 34c, 34d reversed, the antenna 32 would produce vertical linear polarization into the page.

The radiation patterns for the FIG. 3 embodiment are similar to those of FIG. 5A-5C, except that the loop plane null is deeper. Simulations have shown the gain there to be to −54 dBic and the null may be infinitely deep in theory. Reduced loop plane radiation may be advantageous to avoid interference to terrestrial communications when the antenna 32 is pointed overhead. The antenna 32 may have a standing wave current distribution.

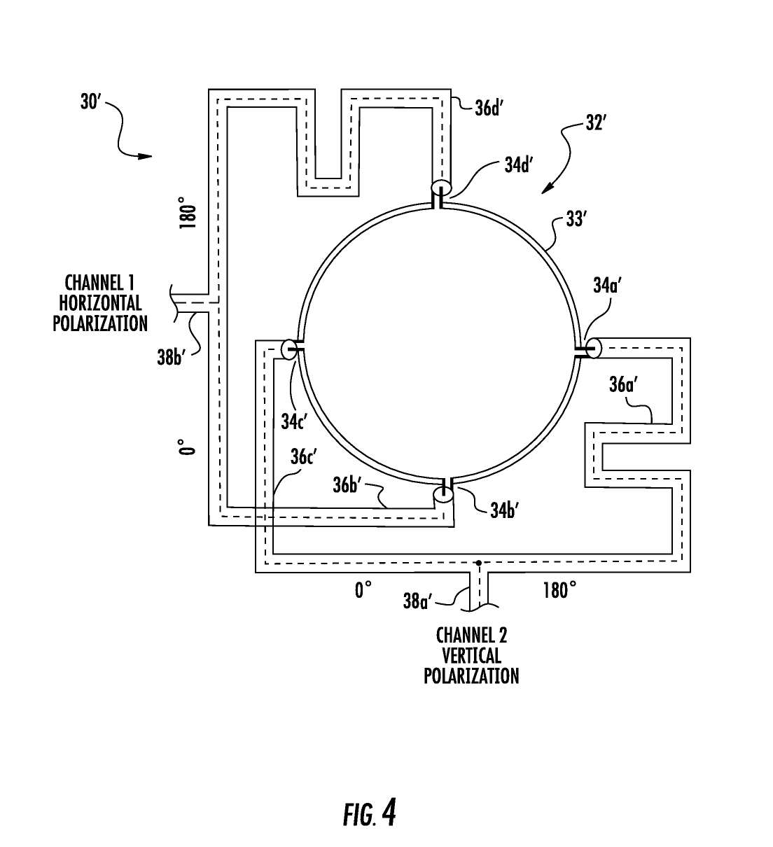

Now, an embodiment of the antenna 30′ that is configured for simultaneous operation using both horizontal and linear polarization, e.g. dual linear polarization or duplexed linear polarization is described with reference to FIG. 4. In this embodiment, there are two antenna feeds 38a′, 38b′ carrying a signal to be transmitted or received using vertical polarization, and a signal to be transmitted or received using horizontal polarization, respectively. The antenna feed 38a′ is coupled to two delay lines 36b′, 36d′, while the antenna feed 38b′ is coupled to the two delay lines 36a′, 3bc′. The delay lines are sized such that the phases at the coupling points 34a′, 34b′, 34c′, 34d′ are −180°, 0°, 0°, and 180°, respectively, thereby providing simultaneous horizontal and vertical polarization.

The ability to operate using both horizontal and vertical polarization simultaneously can provide polarization diversity, and may have the effect of producing greater penetration into buildings and difficult reception areas than a signal with just one plane of polarization. In the antenna 30′, the vertical polarized coupling points 34a′, 34c′ and horizontal polarized coupling points 34b′, 34d′ are isolated from one another, and may also be used as independent communication channels, or for duplex communications. For instance, a transmitter may be included at one of the signal feedpoints, and a receiver used at the other.

The embodiments of the present inventions are not so limited as to require gaps in the loop electrical conductor 13 to form the coupling points 14a, 14b, 14c, 14d. Other approaches may be utilized such as gamma matches, Y matches, or delta matches as are common for dipole and yagi-uda antenna driven elements. In this regard, the textbook “Antennas For All Applications”, John Kraus, Ronald J. Marhefka, 3^{rd} edition, Tata McGraw-Hill, 2002 is identified as a reference in its entirety and the FIG. 23-19 page 822 is referenced in specific.

Table 1 provides a comparison between the antenna 12 and the circularly polarized half wave dipole turnstile antenna:

TABLE 1
Comparison Of The Antenna 12 With The Dipole Turnstile

| | Antenna 12, | |
|---|---|---|
| | Circularly | ½ Wave Dipole |
| Parameter | Polarized Loop | Turnstile |
| Physical | 0.33λ circle | 0.34λ by 0.34λ |
| dimensions | | square (dipoles run |
| | | from corner to |
| | | corner) |
| Subtended | 0.08λ² | 0.12λ² |
| area | | |
| Wire | λ/1000 | λ/1000 |
| diameter | | |
| Realized | 3.6 dBic | 2.1 dBic |
| gain | | |
| Half power | 9B degrees | 126 by 172 degrees |
| beamwidth | | |
| Port | 70 + j0 | 72 + j0 |
| impedances | | |
| 2 to 1 VSWR | 10.7 percent | 11.2 percent |
| bandwidth, | | |
| each port | | |
| 3 dB gain | 30.1 percent | 33.7 percent |
| bandwidth | | |
| Polarization | Circular | Circular |

A full wave circularly polarized loop antenna 12 therefore provides many advantages over the prior art half wave dipole turnstile: more gain, a symmetric beam, reduced size. The bandwidth for size is greater with the loop 12. The antenna 12 provides circular polarization of exceptional circularity: unlike the turnstile it is not easily upset by tolerances. So, the antenna 12 may replace the turnstile in many applications such as satellite communications and ionospheric communications.

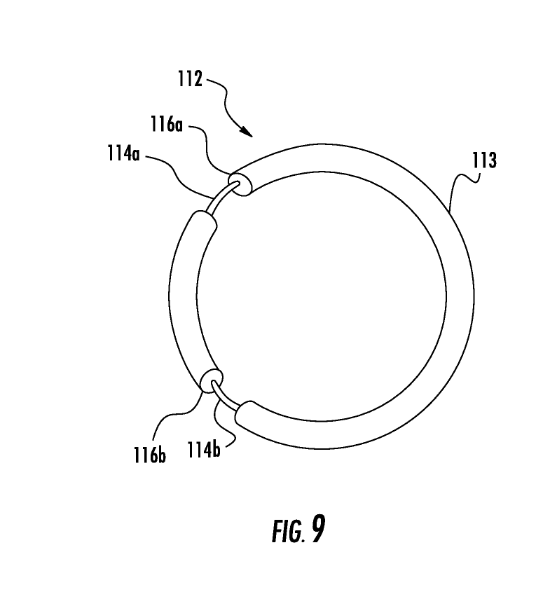

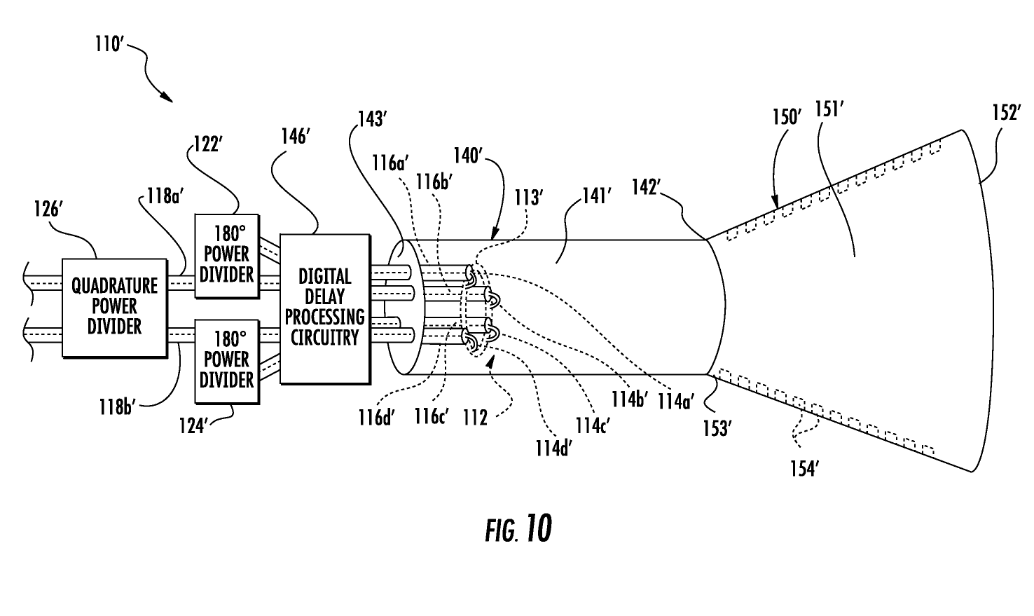

Referring now to FIGS. 8 and 9, in another embodiment, the wireless communications device 110 includes a waveguide transducer 112. The waveguide transducer 112 may be in the form of a circular waveguide, for example. This embodiment may be particularly well suited for feeding conical horns for increased directivity and gain, and it may excite conical horns in the dominant TE₁₁ mode for circular polarization. The waveguide transducer 112 includes a loop electrical conductor 113 having a two spaced apart gaps therein defining a two respective spaced apart coupling points 114a, 114b. The two spaced apart coupling points 114a, 114b are separated by one quarter of a length of the loop electrical conductor 113. The length of the loop electrical conductor corresponds to an operating wavelength of the waveguide transducer. Of course, in some embodiments, the coupling points 114a, 114b may have a different spacing, and the loop electrical conductor 113 may have a different circumference. A larger circumference loop electrical conductor 113 may excite higher order waveguide modes, if desired.

The feed assembly includes two waveguide feeds 118a, 118b, or feed points, and a feed network in the form of two delay lines 116a, 116b coupled between the two waveguide feeds, and the two coupling points 114a, 114b. In other embodiments, the feed network may alternatively or additionally include digital delay processing circuitry configured to provide a delay. In other words, the digital delay processing circuitry may execute computer-executable instructions to provide phase delays. Since there are two coupling points 114a, 114b, and two delay lines 116a, 116b, the 180° power dividers are not used.

The waveguide transducer 112 also includes a waveguide 140 surrounding the loop electrical conductor 113. The loop electrical conductor 113, two delay lines 116a, 116b, the waveguide feeds 118a, 118b, and the waveguide 140 advantageously cooperate to function as a waveguide transducer.

The waveguide 140 extends outwardly from the loop electrical conductor 113, and includes a cylindrical body 141, having an open end 142 and an opposing closed end 143. The closed end 143 carries the loop electrical conductor 113. The body 141 of the waveguide 140 may be another shape.

The reflector 140 may be electrically conductive, for example, and may be metallic. The cylindrically shaped body 141 of the waveguide 140 is sized so that it extends outwardly beyond the loop electrical conductor 113. In other words, the loop electrical conductor 113 is carried below the open end 142 of the cylindrically shaped body 141.

The loop electrical conductor 113 is carried by closed end 143 of cylindrically shaped body 141 in spaced apart relation therefrom. More particularly, the loop electrical conductor 113 is spaced above the closed end 143 by the two delay lines 116a, 116b. A typical spacing of the loop electrical conductor 113 above the closed end 143 by a distance of λ_{g}/4 or a quarter of a wavelength. The cylindrical body 141 may also be 2λ or two wavelengths long from the closed end 143 to the open end 142. Of course, the cylindrical body 141 may be another length, and the loop electrical conductor 113 may be spaced differently.

The waveguide transducer 112 also includes a horn 150 coupled to the open end 142 of the waveguide 140. More particularly, the horn 150 includes a frusto-conical body 151 having a smaller opening 152 coupled to the open end 142 of the waveguide 140 and a larger opening 152 opposing the smaller opening 151. The horn 150 advantageously focuses RF waves from the loop electrical conductor 113 and provides increased gain. The loop electrical conductor 113 excites the waveguide 140 and the horn 150 in the TE11 mode, which is used for satellite communications, for example.

The horn 150 may further include impedance elements 154 carried by an interior of the conical body 151. The impedance elements 154 are illustratively in the form of rings defining a choke. The impedance elements 154 cooperate with the frusto-conical body 151 to reduce current on the interior of the frusta-conical body. As will be appreciated by those skilled in the art, current has a tendency to “walk back” along the frusto-conical body 151.

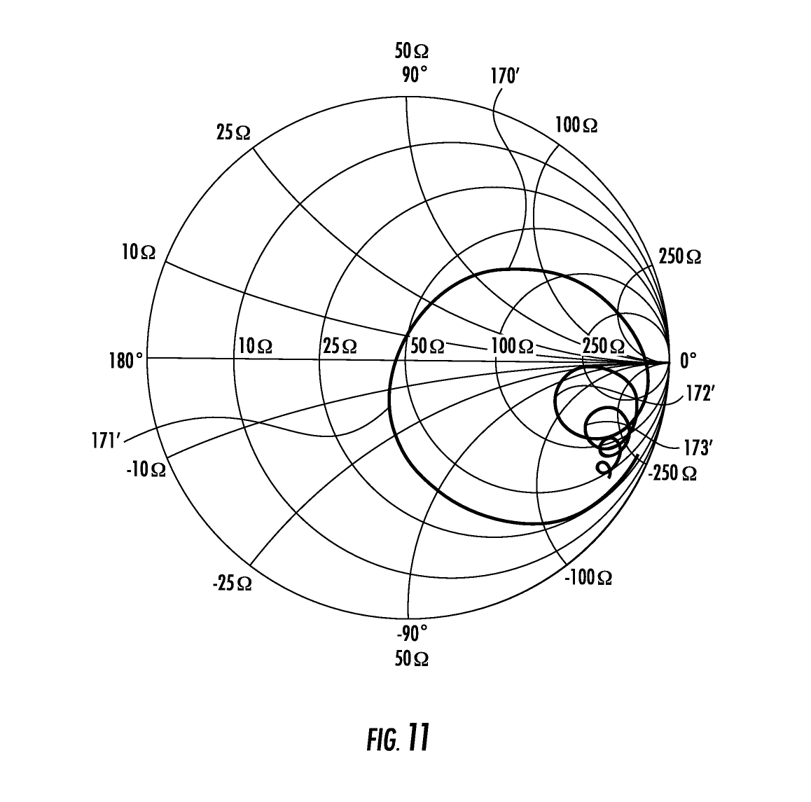

Referring now to FIG. 10, another embodiment of the waveguide transducer 112′ is illustrated. The feed assembly includes two waveguide feeds 118a′, 118b coupled between the quadrature power divider 126′ and the 180° power dividers 122′, 124′. The loop electrical conductor 113′ has four spaced apart gaps therein defining a plurality of four respective spaced apart coupling points 114a′, 114b′, 114c′, 114d′. The feed network is in the form of four delay lines 116a′, 116b′, 116c′, 116d′, as described above, and further includes digital delay processing circuitry 146′. Each delay line 116a′, 116b′, 116c′, 116d′ is coupled between the waveguide feeds 118a′, 118b′ and a respective one of the four coupling points 114a′, 114b′, 114c′, 114d′. The four spaced apart coupling points 114a′, 114b′, 114c′, 114d′ are separated by one quarter of a length of the loop electrical conductor 113′. The length of the loop electrical conductor 113′ corresponds to an operating wavelength of waveguide transducer 112′.

The digital delay processing circuitry 146′ may execute computer-executable instructions and cooperate with the delay lines to provide phase delays of 0°, 90°, 180°, 270°, respectively. In some embodiments, the digital delay processing circuitry 146′ may be used without the four delay lines 116a′, 116b′, 116c′, 116d′. The digital delay processing circuitry 146′ may also be configured to perform additional functions, for example, that of the power dividers 122′, 124′, 126′.

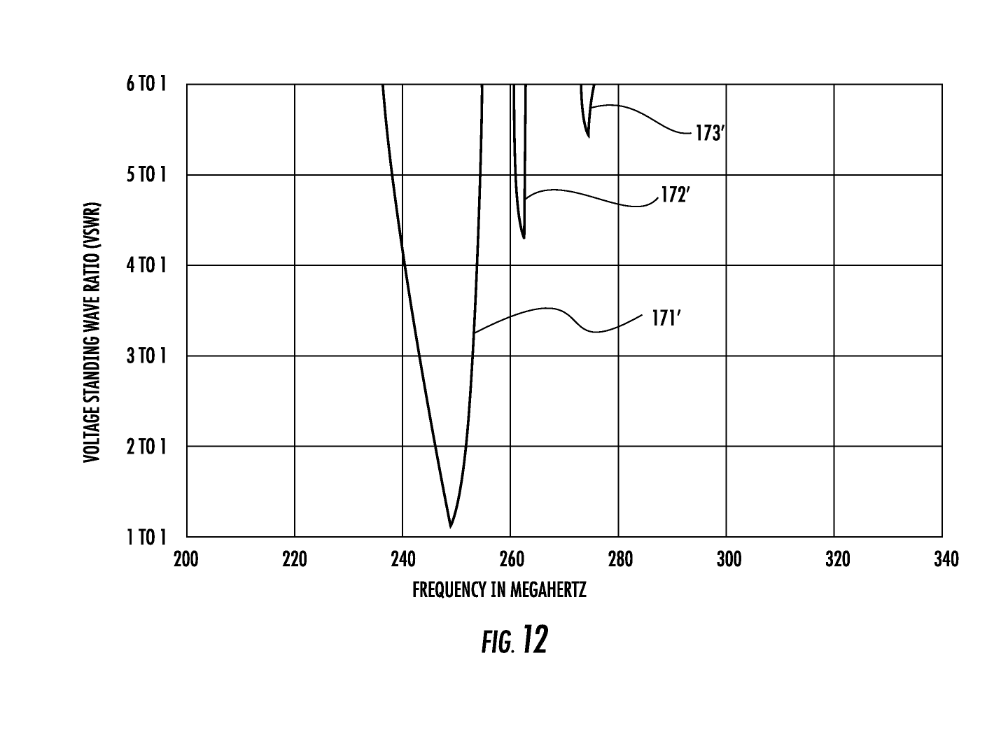

Referring now to FIGS. 11 and 12, a Smith Chart of simulated driving point impedance 170′ for the waveguide transducer 112′ and simulated voltage standing wave ratio (VSWR) are illustrated, respectively. Cusp 171′ corresponds to the TE11 waveguide mode, the cusp 172′ corresponds to the TM01 mode, and the cusp 173′ corresponds to the TE21 mode (FIG. 12). As illustrated in the graphs, the waveguide transducer 112′ tunes and matches to about 50 Ohms. The first resonance occurred at a loop circumference of 0.86 free space wavelengths, e.g. 0.86λ_{free space}. Without the waveguide transducer 112′, the loop electrical conductor 113′ would have had first resonance at about 1.05λ_{free space}. The graph in FIG. 12 is a VSWR response for operation in a 50 ohm system, so a 50 ohm antenna corresponds to a 1 to 1 VSWR, a 100 ohm antenna impedance corresponds to a 2 to 1 VSWR, etc.

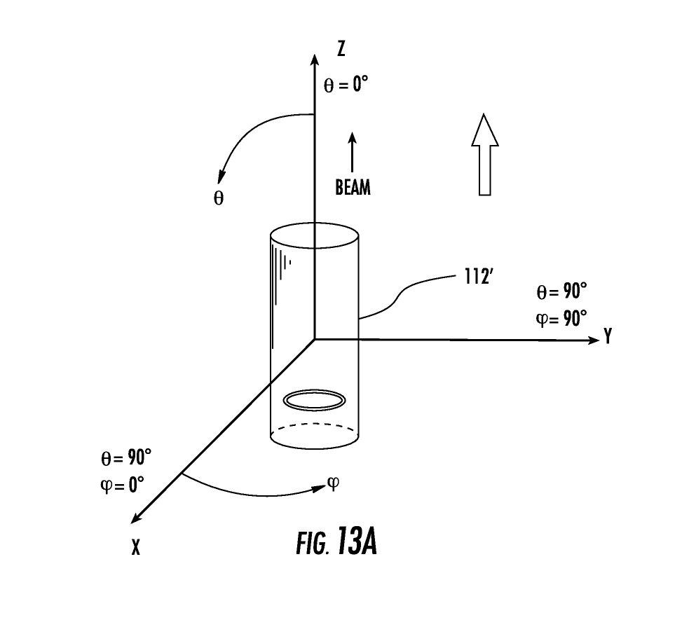

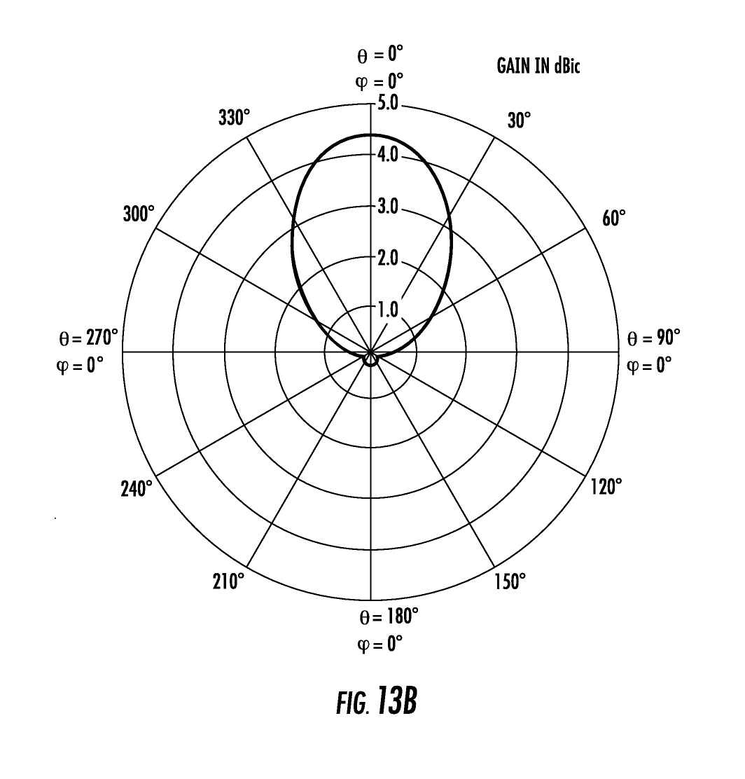

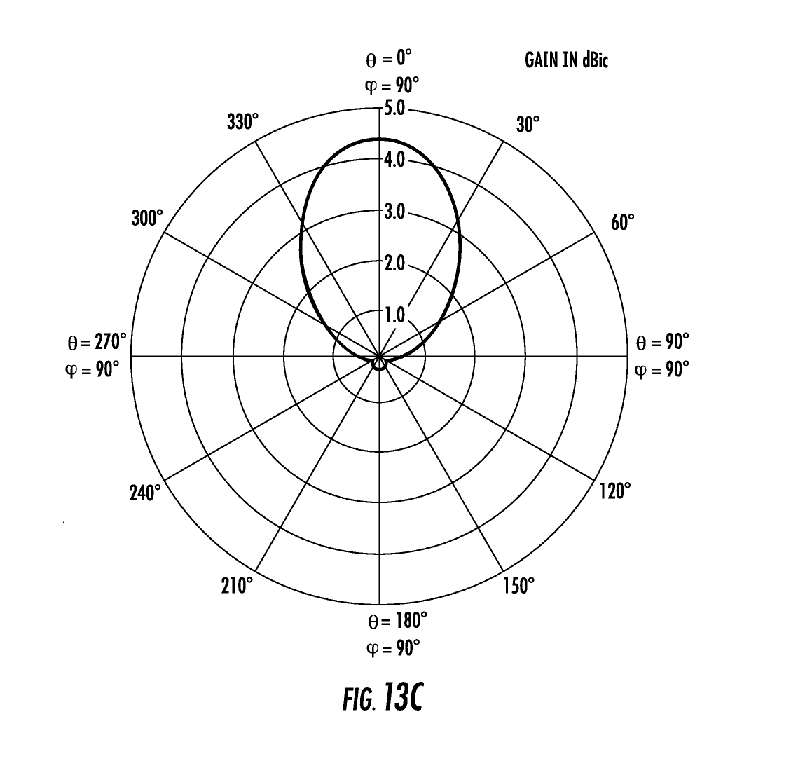

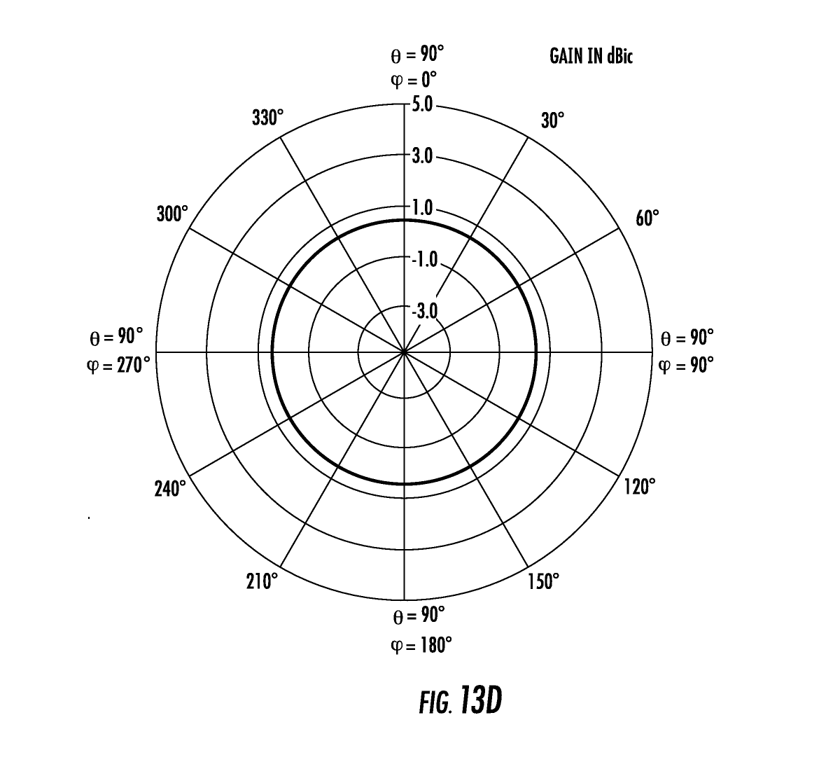

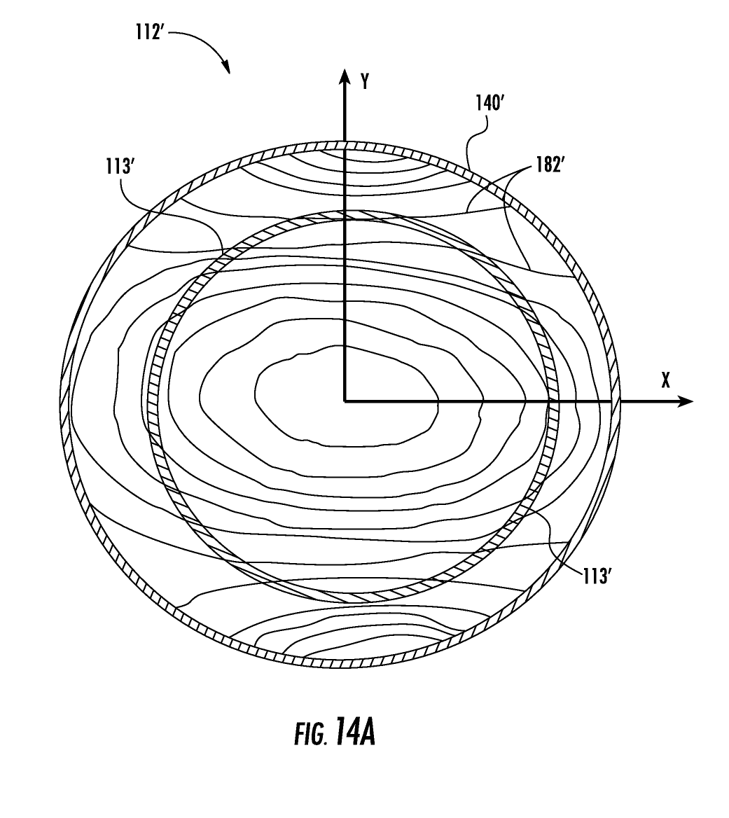

Referring now to FIG. 13a, a waveguide transducer 112′ without the horn 150′ in a radiation pattern coordinating system is illustrated, and FIGS. 13b-13d, simulated radiation patterns for a waveguide transducer 112′ without the horn 150′ are illustrated. In other words, the radiation patterns are for an open ended waveguide having the loop electrical conductor 113′ inside. FIG. 13a illustrates the waveguide transducer 112′ in an industry standard (IEEE-145) radiation pattern coordinate system with the radiated beam oriented along the Z axis. The graph in FIG. 13b illustrates the simulated radiation pattern cut taken in the XZ plane. The graph in FIG. 13c illustrates the simulated radiation pattern cut taken in the YZ plane, and the graph in FIG. 13d illustrates the simulated radiation pattern taken in the X-Y plane. The illustrated radiation patterns are advantageously a rotationally symmetric pattern corresponding to a cosⁿ shape, which may be particularly suited to exciting conical horns and parabolic reflectors, for example.

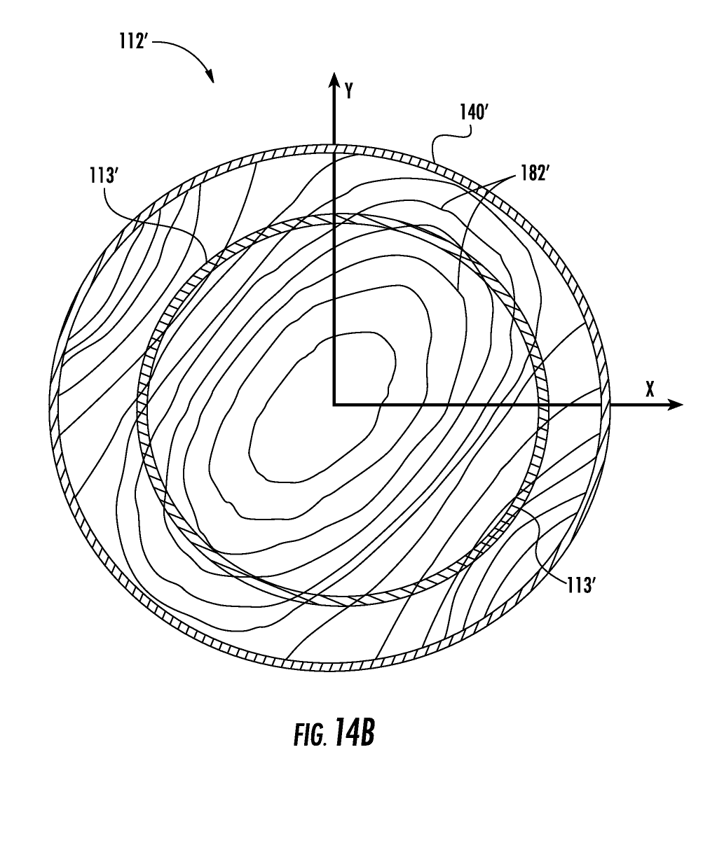

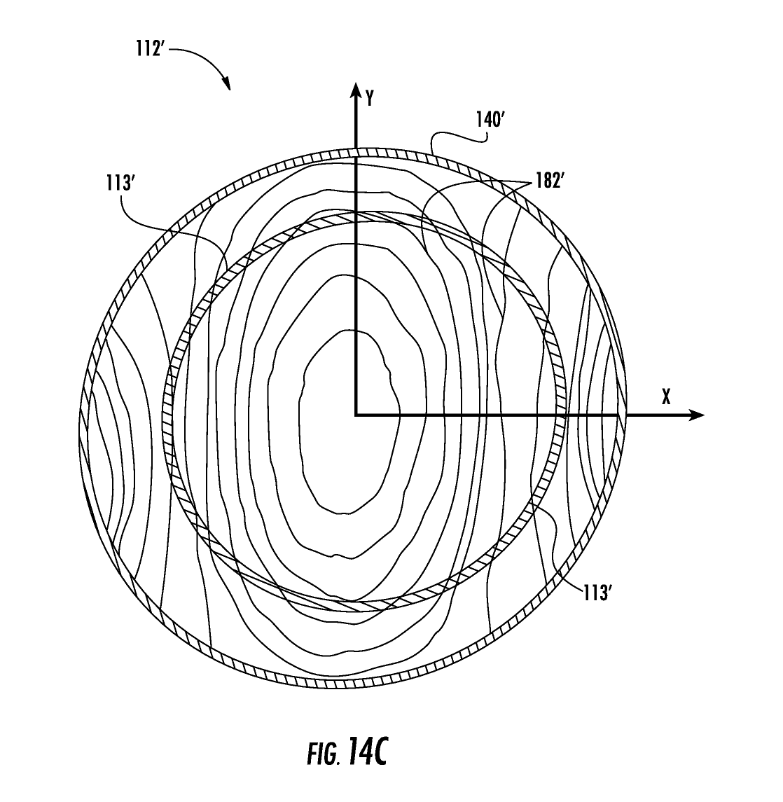

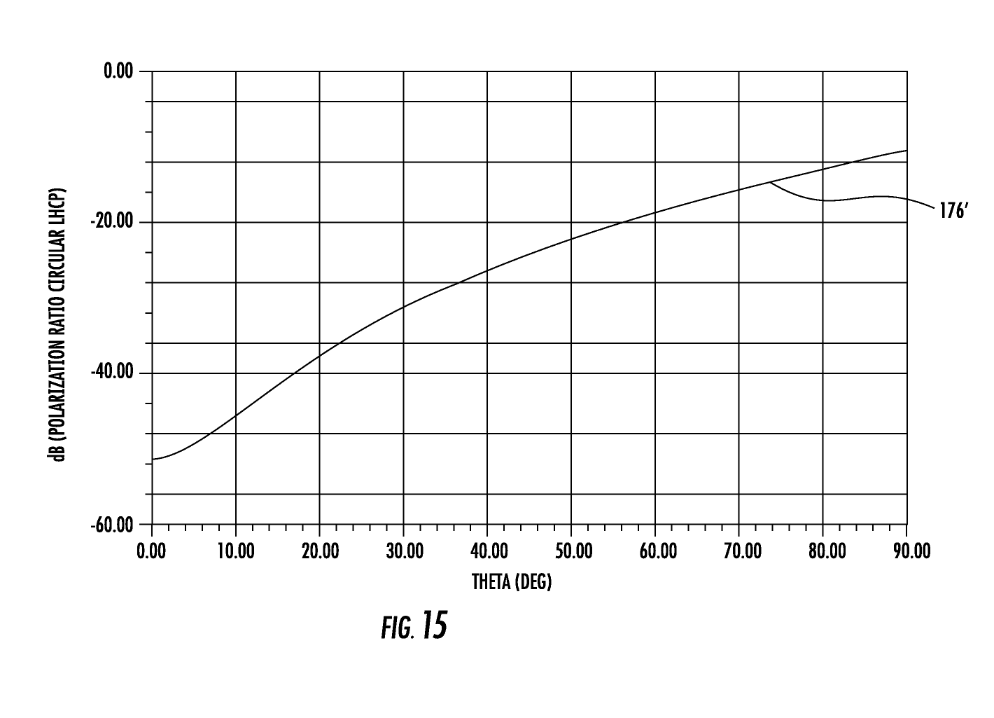

Referring to the graphs in FIGS. 14a-14c, the field rotation of waveguide transducer 112′ in the TE11 mode is illustrated. A cross section of a portion of the waveguide 140′ along with the loop electrical conductor 113′ is illustrated in FIGS. 14a-14c. FIG. 14a illustrates a rotation of 0°. FIG. 14b illustrates, at a later time, a phase rotation of 50°, and FIG. 14c illustrates a phase rotation of 90° at an even later time. The contours 182′ represent constant E field amplitude. As illustrated, the field rotation angularly rotates at ω=2Πf, which advantageously provides circular rotation.

Referring now to the graph in FIG. 15, the simulated axial ratio for the waveguide transducer 112′ is illustrated. The line 176′ illustrates a relatively high axial ratio, thus rejecting left-hand circular polarization. Opposite sense polarization is down 52 dB. Performance specifications for the waveguide transducer 112′ based upon simulations are highlighted below in Table 2, where λ_{fs} are wavelengths in free space.

TABLE 2

| Parameter | Value |
|---|---|
| Device | Waveguide transducer |
| | having circular loop |
| | probe, quadrature |
| | excitation |
| Application | Suitable to conical horn |
| | feed |
| Ring Transducer, Major | 0.86λ_{fs} |
| Circumference Of Toroid | |
| Ring Transducer, Outside | 0.460λ_{fs} |
| Diameter | |
| Ring Transducer, Minor | 0.186λ_{fs} |
| Diameter Of Toroid | |
| Ring Transducer, Centerline | 0.316λ_{fs} |
| Height Above End Wall | |
| Ring Transducer, Centerline | 0.316λ_{fs} |
| Height Above End Wall | |
| Waveguide Type | Circular |
| Waveguide, Inside Diameter | 0.593λ_{fs} |
| Waveguide, Inside | 1.863λ_{fs} |
| Circumference | |
| Waveguide, Length | 3.16λ_{fs} |
| Realized Waveguide Mode | TE₁₁ |
| Number Of Ring Ports | 4, as fine gaps |
| Port Types | 50 ohm coaxial |
| Port Impedance | Z = 46 − j5 Ω |
| VSWR (50 Ω system) | 1.14:1 |
| Loop Excitation | Quadrature |
| Polarization | Circular |
| Gain (open ended waveguide, | 4.36_dBic |
| no horn, splash plate etc,) | |
| 3 db Beamwidth (open ended | 124° |
| waveguide, no horn, splash | |
| plate etc,) | |
| Polarization | Circular |
| Polarization Ratio | 52 dB |
| | (high circularity, |
| | opposite sense down 52 dB) |

A method aspect is directed to a method of making a waveguide transducer 112 for use in a wireless communications device 110. The method includes forming a loop electrical conductor 113 having a plurality of spaced apart gaps therein defining a plurality of respective spaced apart coupling points 114a, 114b, and forming a feed assembly by forming a feed network 116a, 116b and coupling the feed network between the waveguide feeds 118a, 118b and the plurality of coupling points 114a, 114b. The method also includes positioning a waveguide 140 to surround the loop electrical conductor 113 and extend outwardly therefrom. The waveguide 140 includes a tubular body 141 having an open end 142 and an opposing closed end 143 carrying the loop electrical conductor 113.

The embodiments described herein may provide a circular waveguide transducer for the TE11 and other waveguide modes, and a coax to waveguide transition. A circular loop electric conductor may generate electromagnetic fields and may provide one or more of linear polarization, circular polarization, and dual polarization. The embodiments, including the waveguide transducer 112 may simplify reflector antenna feeds by reducing rectangular waveguide components, such as, for example, the magic T hybrid and rectangular to circular waveguide transducers.

Additional details of a wireless communications device including a related antenna may be found in related application attorney docket Nos. GCSD-2490 and GCSD-2491, and U.S. Patent Application Publication No. 2008/0136720 to Parsche et al, all of which are assigned to the present assignee, and the entire contents of each of which are herein incorporated by reference. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A wireless communications device comprising:
wireless communications circuitry; and
a waveguide transducer coupled to said wireless communications circuitry and comprising
a loop electrical conductor having a plurality of spaced apart gaps therein defining a plurality of respective spaced apart coupling points,
a feed assembly comprising
at least one waveguide feed, and
a feed network coupled between said at least one waveguide feed and said plurality of coupling points, and
a waveguide surrounding said loop electrical conductor and extending outwardly therefrom, and comprising a tubular body having an open end and an opposing closed end carrying said loop electrical conductor.

2. The wireless communications device of claim 1, wherein said tubular body comprises a cylindrically shaped body.

3. The wireless communications device of claim 1, wherein said waveguide transducer further comprises a horn coupled to the open end of said waveguide.

4. The wireless communications device of claim 3, wherein said horn comprises a frusto-conical body having a smaller opening coupled to the open end of said waveguide and a larger opening opposing the smaller opening.

5. The wireless communications device of claim 4, wherein said horn further comprises a plurality of impedance elements carried by an interior of said frusto-conical body.

6. The wireless communications device of claim 1, wherein said feed network comprises digital delay processing circuitry.

7. The wireless communications device of claim 1, wherein said loop electrical conductor has two spaced apart gaps therein defining a plurality of two respective spaced apart coupling points.

8. The wireless communications device of claim 7, wherein the two spaced apart coupling points are separated by a quarter of a length of the loop electrical conductor; and wherein the length of said loop electrical conductor corresponds to an operating wavelength of said waveguide transducer.

9. The wireless communications device of claim 1, wherein said loop electrical conductor has four spaced apart gaps therein defining a plurality of four respective spaced apart coupling points.

10. The wireless communications device of claim 9, wherein said feed network comprises four delay lines, each delay line coupled between said at least one waveguide feed and a respective one of said four coupling points.

11. The wireless communications device of claim 9, wherein the four spaced apart coupling points are separated by one quarter of a length of the loop electrical conductor; and wherein the length of said loop electrical conductor corresponds to an operating wavelength of said waveguide transducer.

12. A waveguide transducer for use in a wireless communications device comprising:
a loop electrical conductor having a plurality of spaced apart gaps therein defining a plurality of respective spaced apart coupling points;
a feed assembly comprising
at least one waveguide feed, and
a feed network coupled between said at least one waveguide feed and said plurality of coupling points; and
a waveguide surrounding said loop electrical conductor and extending outwardly therefrom, and comprising a tubular body having an open end and an opposing closed end carrying said loop electrical conductor.

13. The waveguide transducer of claim 12, wherein said tubular body comprises a cylindrically shaped body.

14. The waveguide transducer of claim 12, further comprising a horn coupled to the open end of said waveguide.

15. The waveguide transducer of claim 14, wherein said horn comprises a frusto-conical body having a smaller opening coupled to the open end of said waveguide and a larger opening opposing the smaller opening.

16. The waveguide transducer of claim 15, wherein said horn further comprises a plurality of impedance elements carried by an interior of said frusto-conical body.

17. The waveguide transducer of claim 12, wherein said feed network comprises digital delay processing circuitry.

18. A method of making a waveguide transducer for use in a wireless communications device comprising:
forming a loop electrical conductor having a plurality of spaced apart gaps therein defining a plurality of respective spaced apart coupling points;
forming a feed assembly by forming a feed network and coupling the feed network at least one waveguide feed and the plurality of coupling points; and
positioning a waveguide to surround the loop electrical conductor and extend outwardly therefrom, and comprising a tubular body having an open end and an opposing closed end carrying the loop electrical conductor.

19. The method of claim 18, wherein positioning the waveguide comprising a tubular body comprises positioning a waveguide comprising a cylindrically shaped body.

20. The method of claim 18, further comprising coupling a horn to the open end of the waveguide.

21. The method of claim 20, wherein coupling the horn comprises coupling a horn comprising a frusto-conical body having a smaller opening coupled to the open end of the waveguide and a larger opening opposing the smaller opening.

22. The method of claim 21, wherein coupling the horn comprises coupling a horn comprising a plurality of impedance elements carried by an interior of the frusto-conical body.

23. The method of claim 18, wherein forming the feed assembly by forming a feed network comprises forming the feed assembly by forming digital delay processing circuitry.
